(19) United States
(12) Patent Application Publication
(10) Pub. No.: US 2007/0196740 A1
(43) Pub. Date: Aug. 23, 2007

(54) LITHIUM SECONDARY BATTERY CONTAINING CARBOXYLIC ANHYDRIDE ORGANIC COMPOUND IN ELECTROLYTE

(76) Inventors: Hiroshi Haruna, Hitachi (JP); Eiji Hoshi, Hitachi (JP); Kenji Hara, Iga (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/624,281

(22) Filed: Jan. 18, 2007

(30) Foreign Application Priority Data
Feb. 17, 2006 (JP) 2006-040105

(51) Int. Cl. H01M 10/40

(52) U.S. Cl. 429/326; 429/341; 429/329; 429/330

(57) ABSTRACT

The present invention provides a battery small in time variation of the battery properties from the initial battery properties over a long term storage period of the battery. The battery is a lithium secondary battery in which a positive electrode including a positive electrode active material capable of intercalating and deintercalating lithium ions and a negative electrode including a negative electrode active material capable of intercalating and deintercalating lithium ions are formed through the intermediary of an electrolyte, wherein: the negative electrode active material is a carbon material having a crystallinity of the surface thereof lower than the crystallinity of the carbon material; and the electrolyte contains an organic compound having a carboxylic anhydride group.

### BACKGROUND OF THE INVENTION

1. Field of the Invention

The present invention relates to a lithium secondary battery including a carboxylic anhydride organic compound.

2. Background Art

Recently, power sources for mobile communication devices such as cellular phones and portable personal computers have been increasingly demanded to be reduced in size and to have high energy density. On the other hand, midnight power storage systems and power storage systems involving solar cells and wind-power generation have also been increasingly developed. Also, from the viewpoint of environmental issues as typified by the California State regulations, electric vehicles, and hybrid vehicles and hybrid electric trains using electric power as a part of the motive energy thereof have been increasingly put in practical use.

However, nonaqueous electrolyte lithium secondary batteries utilizing as the negative electrode materials carbonaceous materials, silicon materials, metal oxides and the like have suffered from such problems that the organic solvent included in the electrolyte is reductively decomposed on the negative electrode surface in the charge-discharge process, and the negative electrode impedance is increased with time due to the gas generation and the deposition of the reductively decomposed substances of the organic solvent to lead to the battery capacity degradation.

Accordingly, for the purpose of suppressing the above described reductive decomposition of the organic solvent, various compounds have hitherto been added to the electrolyte as means for suppressing the reductive decomposition of the organic solvent on the negative electrode, and the technique to control the morphology of the negative electrode surface coating has become significant. For example, JP Patent Publication (Kokai) No. 2001-057234 A, JP Patent Publication (Kokai) No. 2004-14352 A and JP Patent Publication (Kokai) No. 2004-022379 A disclose the addition of vinylene carbonate, a pyridine derivative and lithium difluoroacetate to the electrolyte, respectively. However, even the use of these compounds as additives results in battery storage performance insufficient to meet the recent high capacity and high output power lithium secondary batteries.

### SUMMARY OF THE INVENTION

The problem to be solved by the present invention is related to the provision of a battery small in time variation of the battery properties from the initial battery properties over a long term storage period of the battery.

The present inventors have found that using a nonaqueous electrolyte containing a carboxylic anhydride organic compound as the electrolyte of a battery results in an excellent high-temperature storage performance and an excellent charge-discharge efficiency of the battery. Additionally, the inclusion of a carboxylic anhydride organic compound in the negative electrode has also revealed to give similar effects.

The carboxylic acid as referred to herein has a carboxyl group COOH in the molecule thereof and the carboxyl group includes a hydrogen atom or an alkyl group bonded thereto. A carboxylic acid having one, two or three carboxyl groups in the molecule thereof is referred to as a monocarboxylic, dicarboxylic or tricarboxylic acid, respectively. A carboxylic acid is classified into as a chain-type or cyclic-type carboxylic acid, or a saturated or an unsaturated carboxylic acid, according to the type of the hydrocarbon group bonded to the carboxyl group.

The carboxylic anhydride organic compound according to the present invention is represented by formula (1) or (2), where R₁ and R₂ in formula (1) each are an organic group having 1 to 20 carbon atoms and are different from each other, Rₙ and Rₘ in formula (2) each are an organic group having 1 to 5 carbon atoms and are different from each other, and R₁, R₂, Rₙ and Rₘ each include at least one element selected from the group consisting of hydrogen, sulfur, oxygen, nitrogen, fluorine, chlorine, bromine and iodine.

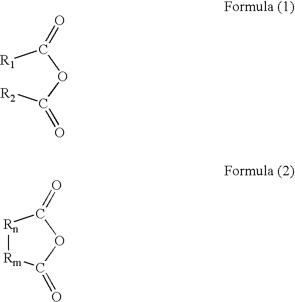

The present invention provides a nonaqueous electrolyte including a compound represented by above formula (1) or (2), and a lithium secondary battery using the nonaqueous electrolyte.

According to the present invention, there can be obtained a lithium secondary battery capable of controlling the generation morphology of the protective coating on the negative electrode surface and excellent in high-temperature storage performance.

### BRIEF DESCRIPTION OF THE DRAWING

FIG. 1 is a longitudinal sectional view of a lithium secondary battery.

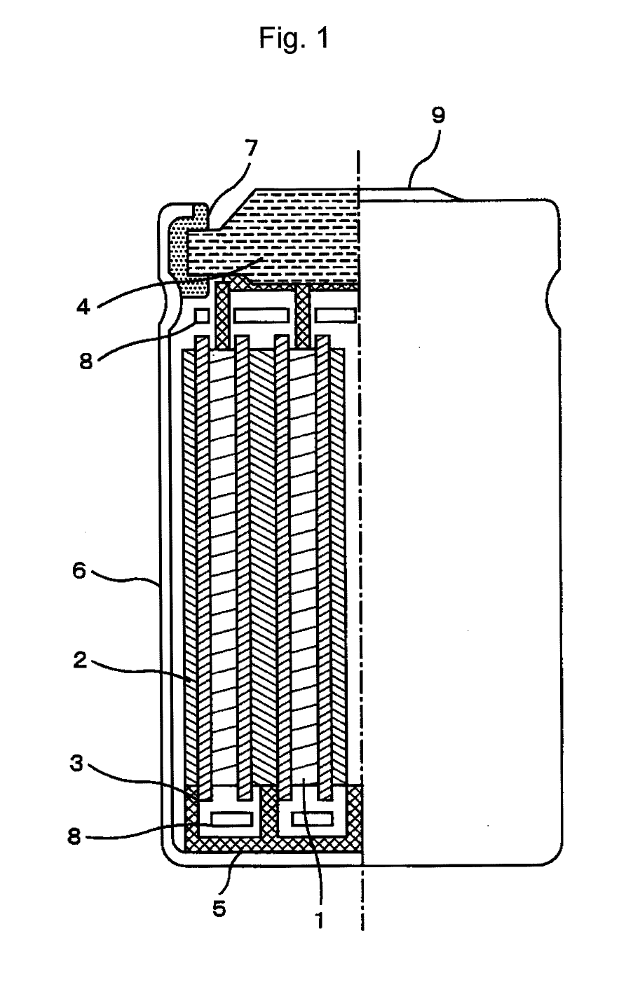

Each numeral in FIG. 1 means the following.
1—positive electrode plate
2—negative electrode plate
3—separator
4—positive electrode lead
5—negative electrode lead
6—battery can
7—packing
8—insulating plate
9—sealing cap

### DETAILED DESCRIPTION OF THE PREFERRED EMBODIMENTS

In the present invention, it is preferable to use a carboxylic acid anhydride organic compound in which R₁ and R₂ in above formula (1) each are an organic group having 1 to 20 carbon atoms and are different from each other, and R₁ and R₂ each are represented by a general formula CₗHₘXₙ wherein l, m and n are natural numbers, 2l+1=m+n, 1≦l≦5, 3≦m≦11, 3≦n≦11, and X includes at least one halogen atom.

Additionally, another preferable compound is a carboxylic acid anhydride organic compound in which Rₙ and Rₘ in above formula (2) each are an organic group having 1 to 5 carbon atoms and are different from each other, and Rₙ and Rₘ each are represented by a general formula CₗHₘXₙ wherein l, m and n are natural numbers, 2l−1=m+n, 1≦l≦5, 2≦m≦9, 3≦n≦9, and X includes at least one halogen atom.

The carboxylic anhydride organic compound represented by above formula (1) or (2) is suitable as an additive to a nonaqueous electrolyte.

The present invention provides an electrolyte for use in nonaqueous secondary batteries which is prepared as follows and added with the above described additive; the electrolyte concerned is prepared by dissolving a lithium salt in a mixed solvent composed of a chain-type or cyclic-type carbonate compound, a chain-type or cyclic-type ester, a chain-type or cyclic-type ether compound and/or a compound in which the functional groups of the carbonate compound are partially substituted with other functional groups. The content of the above described additive preferably falls within a range from 0.01 to 10% by weight.

Further, the present invention provides a lithium secondary battery in which a positive electrode including a positive electrode active material capable of intercalating and deintercalating lithium ions and a negative electrode including a negative electrode active material capable of intercalating and deintercalating lithium ions are formed through the intermediary of an electrolyte, wherein the electrolyte contains a carboxylic anhydride organic compound. Additionally, the lithium secondary battery can include in the negative electrode thereof a carboxylic anhydride organic compound which is represented by above formula (1) or (2), and is a solid at room temperature (25° C.) or a liquid having a boiling point higher than that of a dispersant to be used in the coating of the negative electrode.

Now, the molecular symmetry is described. The chemical formula (a) (R denoting an organic group) is provided with an auxiliary line a and a symmetry axis a. The auxiliary line a is a straight line connecting C₁ and C₂ in the chemical formula (a), and the symmetry axis a is a normal to the auxiliary line a. With reference to the chemical formula (a), a compound in which R₁=R₂ and a line symmetry is found with respect to the symmetry axis a is referred to as a symmetric carboxylic anhydride organic compound, and a compound in which R₁≠R₂ and no line symmetry is found with respect to the symmetry axis a is referred to as an asymmetric carboxylic anhydride organic compound.

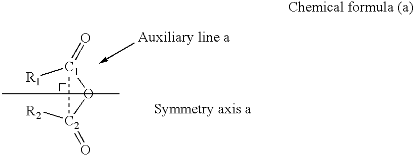

The carboxylic anhydride organic compounds to be used in the nonaqueous lithium secondary battery of the present invention are classified into the following four types, namely, chain-type carboxylic anhydride organic compounds the molecules of which are symmetric, cyclic-type carboxylic anhydride organic compounds the molecules of which are symmetric, chain-type carboxylic anhydride organic compounds the molecules of which are asymmetric, and cyclic-type carboxylic anhydride organic compounds the molecules of which are asymmetric.

The lithium secondary battery of the present invention is characterized by including at least one compound selected from the following: chain-type carboxylic anhydride organic compounds the molecules of which are symmetric such as poly(adipic anhydride), poly(azelaic anhydride), poly(sebacic anhydride) and poly(ethyloctadecanoic diacid) anhydride; cyclic-type carboxylic anhydride organic compounds the molecules of which are symmetric such as hexahydrophthalic anhydride, tetrahydrophthalic anhydride, trialkyltetrahydrophthalic anhydride, phthalic anhydride, pyromellitic anhydride and tetrabromophthalic anhydride; chain-type carboxylic anhydride organic compounds the molecules of which are asymmetric such as dodecenyl succinic anhydride and poly(phenylhexadecanoic diacid) anhydride; and cyclic-type carboxylic anhydride organic compounds the molecules of which are asymmetric such as methyltetrahydrophthalic anhydride, methylhexahydrophthalic anhydride, 5-norbornene-2,3-dicarboxylic anhydride, methylcyclohexenedicarboxylic ahydride, trimellitic anhydride, benzophenonetetracarboxylic anhydride, ethylene glycol bistrimellitate, glycerol tristrimellitate, chlorendic anhydride, itaconic anhydride, citraconic anhydride, alkenyl anhydride, tricarballyic anhydride, the linolenic acid adduct of maleic anhydride, an electrolyte-soluble maleic anhydride-vinyl ether copolymer, an electrolyte-soluble maleic anhydride-styrene copolymer, the maleic anhydride adduct of methylcyclopentadiene, alkylated endoalkylenetetrahydrophthalic anhydride, methyl-2-substituted-butenyltetrahydrophthalic anhydride, and glycerin tristrimellitate.

Preferred among these compounds are particularly those compounds having at least a carbon-carbon double bond such as, itaconic anhydride, citraconic anhydride, dodecenyl succinic anhydride, the linolenic acid adduct of maleic anhydride, the maleic anhydride adduct of methylcyclopentadiene, chlorendic anhydride, alkylated endoalkylenetetrahydrophthalic anhydride, methyl-2-substituted-butenyltetrahydrophthalic anhydride, methyltetrahydrophthalic anhydride, 5-norbornene-2,3-dicarboxylic anhydride, trialkyltetrahydrophthalic anhydride, methylcyclohexenedicarboxylic ahydride, phthalic anhydride, trimellitic anhydride, pyromellitic anhydride, benzophenonetetracarboxylic anhydride, ethylene glycol bistrimellitate, glycerol tristrimellitate, chlorendic anhydride, and tetrabromophthalic anhydride.

The action mechanism of the organic compounds, to be used in the present invention, each having a carboxylic anhydride group is conceivably the formation of the coating, in the initial cycle, on the negative electrode surface in contact with the electrolyte through converting into a polymer insoluble in the electrolyte. Also, it has been revealed that, in the case of the compounds each having a carboxylic anhydride group and at least a carbon-carbon double bond, the polymerization reaction is made to proceed faster, and additionally an excellent high-temperature storage performance is attained through formation of the dimer or higher-multimer coating. Further, when the carboxylic anhydride organic compound is an asymmetric compound, the reduction product thereof has also a stereoregularity; thus, as compared to the case where vinylene carbonate (VC) is used, the interface control can be made at a molecular level and a denser coating is conceivably generated. The coating performance of the negative electrode surface is enhanced owing to the dense coating, and thus a battery having an excellent high-temperature storage performance can be conceivably provided.

The carboxylic anhydride organic compounds to be used in the present invention may be classified as follows with reference to the above depicted chemical formula (a).

(1) A carboxylic anhydride organic compound which is an organic compound having a carboxylic anhydride group, and has a molecular structure having a line symmetry with respect to the symmetry axis a in the chemical formula (a), wherein R₁ and R₂ in the chemical formula (a) each are an organic group having 1 to 20 carbon atoms and at least one carbon-carbon double bond, and each include at least one element selected from the group consisting of hydrogen, sulfur, oxygen, nitrogen, fluorine, chlorine, bromine and iodine.

(2) A carboxylic anhydride organic compound which is an organic compound having a carboxylic anhydride group, and has a molecular structure having a line symmetry with respect to the symmetry axis a in the chemical formula (a), wherein R₁ and R₂ in the chemical formula (a) each are an organic group having 1 to 20 carbon atoms and at least one carbon-carbon double bond, and each include at least one element selected from the group consisting of hydrogen, sulfur, oxygen, nitrogen, fluorine, chlorine, bromine and iodine, and R₁ and R₂ are bonded to each other to form a ring.

(3) A carboxylic anhydride organic compound which is an organic compound having a carboxylic anhydride group, and has a molecular structure asymmetric with respect to the symmetry axis a in the chemical formula (a), wherein R₁ and R₂ in the chemical formula (a) each are an organic group having 1 to 20 carbon atoms and at least one carbon-carbon double bond, and each include at least one element selected from the group consisting of hydrogen, sulfur, oxygen, nitrogen, fluorine, chlorine, bromine and iodine, and R₁ and R₂ are different from each other.

(4) A carboxylic anhydride organic compound which is an organic compound having a carboxylic anhydride group, and has a molecular structure asymmetric with respect to the symmetry axis a in the chemical formula (a), wherein R₁ and R₂ in the chemical formula (a) each are an organic group having 1 to 20 carbon atoms and at least one carbon-carbon double bond, and each include at least one element selected from the group consisting of hydrogen, sulfur, oxygen, nitrogen, fluorine, chlorine, bromine and iodine, and R₁ and R₂ are bonded to each other to form a ring.

(5) A carboxylic anhydride organic compound which is an organic compound having a carboxylic anhydride group, and has a molecular structure having a line symmetry with respect to the symmetry axis a in the chemical formula (a), wherein R₁ and R₂ in the chemical formula (a) each are at least one organic group having 1 to 20 carbon atoms, and each include at least one element selected from the group consisting of hydrogen, sulfur, oxygen, nitrogen, fluorine, chlorine, bromine and iodine.

(6) A carboxylic anhydride organic compound which is an organic compound having a carboxylic anhydride group, and has a molecular structure having a line symmetry with respect to the symmetry axis a in the chemical formula (a), wherein R₁ and R₂ in the chemical formula (a) each are at least one organic group having 1 to 20 carbon atoms, and each include at least one element selected from the group consisting of hydrogen, sulfur, oxygen, nitrogen, fluorine, chlorine, bromine and iodine, and R₁ and R₂ are bonded to each other to form a ring.

(7) A carboxylic anhydride organic compound which is an organic compound having a carboxylic anhydride group, and has a molecular structure asymmetric with respect to the symmetry axis a in the chemical formula (a), wherein R₁ and R₂ in the chemical formula (a) each are at least one organic group having 1 to 20 carbon atoms, and each include at least one element selected from the group consisting of hydrogen, sulfur, oxygen, nitrogen, fluorine, chlorine, bromine and iodine.

(8) A carboxylic anhydride organic compound which is an organic compound having a carboxylic anhydride group, and has a molecular structure asymmetric with respect to the symmetry axis a in the chemical formula (a), wherein R₁ and R₂ in the chemical formula (a) each are at least one organic group having 1 to 20 carbon atoms, and each include at least one element selected from the group consisting of hydrogen, sulfur, oxygen, nitrogen, fluorine, chlorine, bromine and iodine, and R₁ and R₂ are bonded to each other to form a ring.

In the present invention, the nonaqueous electrolyte containing a lithium salt dissolved therein as an electrolyte salt is added with a carboxylic anhydride organic compound depicted in the chemical formula (a). The proportion of the carboxylic anhydride organic compound to be used in the present invention, in the electrolyte, is preferably 0.01 to 10% by weight in relation to the weight of the electrolyte. When the proportion is less than 0.01% by weight, it is not enough to coat the electrode surface to conceivably result in insufficient coating effects. When the proportion is 10% by weight or more, the resistance value is unfavorably increased because of the facts such as the increased viscosity of the electrolyte and the degraded solubility in the electrolyte. The proportion is more preferably 0.01 to 5% by weight. When the carboxylic anhydride organic compound is a solid at room temperature (25° C.) or is a liquid higher in boiling point than a dispersant such as NMP (N-methylpyrrodinone) to be used in coating the negative electrode, the carboxylic anhydride organic compound can also be mixed in the negative electrode material at the time of the negative electrode coating. This is because the dispersant such as NMP is eventually evaporated, and a carboxylic anhydride organic compound higher in boiling point than the dispersant is not evaporated with NMP to be able to remain in the negative electrode. It is to be noted that the boiling point of NMP is 204° C. under the conditions of 25° C. and an atmospheric pressure of 1 atm.

When the carboxylic anhydride organic compound is mixed in the negative electrode, the proportion thereof is preferably 0.01 to 10% by weight in relation to the amount of the electrolyte to be poured into the battery. When the proportion is less than 0.01% by weight, it is not enough to coat the electrode surface to result in insufficient coating effects. When the proportion is 10% by weight or more, the resistance value is unfavorably increased because of the facts such as the increased viscosity of the electrolyte and the degraded solubility in the electrolyte.

The nonaqueous solvents to be used in the present invention are cyclic-type carbonates, chain-type carbonates, straight-chain-type carboxylic acid esters, lactones, cyclic-type ethers and chain-type ethers. By using one or more of these compounds to prepare a mixed solvent, a lithium salt is dissolved as a solute into the mixed solvent to prepare the nonaqueous electrolyte. Specific examples of the nonaqueous solvents include ethylene carbonate, propylene carbonate, gamma-butyrolactone, dimethyl carbonate, ethyl methyl carbonate and diethyl carbonate. Halides such as fluorine substitution products and sulfur substitution products of these solvents can also be used.

These solvents may be used each alone or as mixtures of two or more thereof. However, in general, preferred are mixed solvents each composed of a high-viscosity solvent such as a cyclic-type carbonate or a cyclic-type lactone and a low-viscosity solvent such as a chain-type carbonate or a chain-type ester.

Specific examples of the lithium salt to be the solute include LiPF₆, LiBF₄, LiClO₄, LiAsF₆, LiSbF₆, LiAlCl₄, LiCF₃SO₃, Li(CF₃SO₂)₂N and Li(C₂F₅SO₂)₂N; preferred among these are LiPF₆ and LiBF₄. These lithium salts may be used each alone or as mixtures of two or more thereof.

The positive electrode active material, to be used in the present invention, reversibly intercalating and deintercalating lithium ions includes one or more selected from the following: layered compounds such as lithium cobaltate (LiCoO₂), lithium nickelate (LiNiO₂), and the compounds derived from these by substituting with one or more transition metals; lithium manganates such as Li₁₊ₓMn₂₋ₓO₄ (x=0 to 0.33), Li₁₊ₓMn_{2-x-y}M_{y}O₄ (M including at least one metal selected from the group consisting of Ni, Co, Fe, Cu, Al and Mg, x=0 to 0.33, y=0 to 1.0, and 2−x−y>0), LiMnO₄, LiMn₂O₄, LiMnO₂, LiMn₂₋ₓO₂ (M including at least one metal selected from the group consisting of Ni, Co, Fe, Cu, Al and Mg, and x=0.01 to 0.1), and Li₂Mn₃MO₈ (M including at least one metal selected from the group consisting of Ni, Co, Fe and Cu); a copper-lithium oxide (Li₂CuO₂); disulfide compounds; mixtures including Fe₂(MoO₄)₃; and polyaniline, polypyrrole and polythiophene.

Examples of the usable negative electrode active material reversibly intercalating and deintercalating lithium ions include the following: natural graphite; products obtained by processing, at high temperatures of 2500° C. or higher, petroleum coke, coal pitch coke and the like readily convertible into graphite; mesophase carbon; amorphous carbon; products obtained by coating the surface of graphite with amorphous carbon; carbon materials obtained by mechanically processing graphite carbon that is a carbon material having a high crystallinity so as to be decreased in the surface crystallinity; carbon fiber; lithium metal; metals alloyable with lithium; and materials obtained by supporting metals on the surface of silicon particles or carbon particles. Examples of the metals supported on the carbon materials include: the metals selected from the group consisting of lithium, aluminum, tin, silicon, indium, gallium and magnesium; and the alloys of these. The metals and the oxides thereof can also be used as the negative electrode active material.

In the present invention, the fabrication of the lithium secondary battery is carried out as follows. First, a slurry is prepared by mixing the above described positive electrode active material with a carbon material powder as a conducting agent and a binder such as polyvinylidene fluoride (PVDF). The mixing ratio of the conducting agent to the positive electrode active material is preferably 5 to 20% by weight. In the mixing concerned, sufficient kneading is carried out with a mixing machine equipped with agitation means such as rotary blades, for the purpose of homogeneously dispersing the powder particles of the positive electrode active material. The fully mixed slurry is applied on the both surfaces of a 15 to 25 μm thick aluminum foil with a coating machine such as a roll transfer printing coating machine. The aluminum foil thus coated is subjected to press drying to prepare an electrode plate for the positive electrode. The thickness of the electrode coating composite is preferably set to be 20 to 100 μm. For the negative electrode, graphite, amorphous carbon or a mixture of these is used as the active material, the active material is mixed with a binder in the same manner as for the positive electrode, and the mixture is applied and pressed to prepare the negative electrode. The thickness of the electrode composite is preferably set to be 20 to 70 μm. For the negative electrode, a 7 to 20 μm thick copper foil is used as a current collector. The mixing ratio for coating is preferably, for example, such that the weight ratio of the negative electrode active material to the binder is 90:10.

The coated electrodes thus obtained each are cut to a predetermined length, and tabs for taking out the electric current are formed thereon by spot welding or ultrasonic welding to the electrodes. The tabs are formed of metal foils which are the same in material as the rectangular current collectors, respectively, and are provided for the purpose of taking out the electric current from the electrodes. The lithium secondary battery of the present invention for mobile devices is required to flow a large electric current, and hence the number of the tabs on each of the electrodes is needed to be two or more. The electrodes each having the tabs fixed thereon, and a separator formed of a porous resin such as polyethylene (PE) or polypropylene (PP) are laminated so as for the separator to be interposed between the electrodes, the thus obtained laminate is rolled into a cylindrical shape to form a group of electrodes, and the group of electrodes is housed in a cylindrical vessel. Alternatively, bag-like separators may be used to house the electrodes therein, and such separators each including an electrode may be laminated to be housed in a rectangular vessel. The material for forming the vessel is preferably stainless steel or aluminum. After the group of electrodes has been housed in the battery vessel, an electrolyte is poured into the vessel, and then the vessel is sealed. It is preferable to use as the electrolyte an electrolyte which is prepared by dissolving, as a solute to be an electrolyte salt, a lithium salt such as LiPF₆, LiBF₄ or LiClO₄ in a solvent such as ethylene carbonate (EC), propylene carbonate (PC) or dimethyl carbonate (DMC). The concentration of the electrolyte salt is preferably between 0.7 M and 1.5 M. The pouring of the electrolyte and the subsequent sealing of the battery vessel complete the battery.

Description is made below on the embodiments of the present invention.

Hereinafter, specific description is further made on the present invention on the basis of Examples of the present invention and Comparative Examples. However, the present invention is not limited by these Examples.

### EXAMPLE 1

The lithium secondary battery of the present invention was fabricated as follows.

As the positive electrode active material, Li[CO_{1/3}Ni_{1/3}Mn_{1/3}]O₂ was adopted. A positive electrode slurry was prepared by mixing a conducting agent obtained by mixing agglomerate graphite and acetylene black in a ratio of 9:2, a binder that was an NMP solution of PVDF beforehand regulated to have a PVDF content of 5% by weight, and the positive electrode active material. The mixing ratio between the positive electrode active material, the conducting agent and PVDF was set at 85:10:5 by weight. The slurry was uniformly and evenly coated on one surface of a 20 μm thick aluminum foil (a positive electrode current collector). After coating, the coated slurry was dried at 80° C.; thereafter, the other side of the aluminum foil was coated and dried in the same manner as described above. The coated aluminum foil thus prepared was subjected to compression molding with a roll press, cut to a coating dimension of 5.4 cm in width and 50 cm in length, and an aluminum-foil lead tab for taking out the electric current was welded onto the cut aluminum foil to prepare a positive electrode plate.

As the negative electrode active material, a carbon material obtained by mechanically processing a high-crystallinity carbon material, namely, graphite carbon so as to have a low surface crystallinity was adopted. A negative electrode slurry was prepared by mixing the negative electrode active material and the NMP solution of PVDF so as to be sufficiently kneaded with each other. It is to be noted that the crystallinity as referred to herein means the degree of crystallization that is a physical property representing the proportion (in terms of mass ratio) of the crystalline portion in a material composed of a crystalline portion and an amorphous portion. Thus, it is meant that with decreasing crystallinity, approaching degree to amorphousness is increased. The mixing ratio between the negative electrode active material and PVDF was set at 90:10 by weight. The slurry was uniformly and evenly coated on one surface of a 10 μm thick rolled copper foil (a negative electrode current collector). In the same manner as in the case of the positive electrode, the slurry was coated on both surfaces of the rolled copper foil and dried. After coating, the coated copper foil thus prepared was subjected to compression molding with a roll press, cut to a coating dimension of 5.6 cm in width and 54 cm in length, and a copper-foil lead tab was welded onto the cut copper foil to prepare a negative electrode plate.

By using the prepared positive electrode plate and the prepared negative electrode plate, a cylindrical battery schematically shown in FIG. 1 was fabricated. The prepared positive electrode plate 1, the prepared negative electrode plate 2 and a separator 3 were rolled together in such a way that the separator 3 was interposed between these electrodes to make these electrodes out of touch with each other. Thus, a group of electrodes was prepared. In this rolling, a positive electrode plate lead 4 and a negative electrode plate lead 5 were disposed respectively on the opposite ends of the rolled group of the electrodes. Further, the composite coated portion of the positive electrode was made not to protrude from the composite coated portion of the negative electrode. For the separator, a microporous polypropylene film of 40 μm in thickness and 5.8 cm in width was used. The group of electrodes was inserted into a SUS battery can 6, the negative electrode lead tab 5 was welded onto the bottom of the can, and the positive electrode lead tab 4 was welded to a sealing cap 9 doubling as a positive electrode current terminal. Further, any one of the lithium secondary battery electrolytes to be described later in Experimental Examples 1 to 7 and Comparative Examples 1 and 2 was poured into the battery can, the sealing cap 9 with the positive electrode terminal fixed thereon was caulked to the battery can 6 through the intermediary of a packing 7 to seal the can, and thus a cylindrical battery of 18 mm in diameter and 65 mm in length was fabricated. It is to be noted that an escape valve was disposed on the sealing cap 9 to release the internal pressure of the battery through the cracking thereof caused by the increased internal pressure of the battery. It is also to be noted that Reference Numeral 8 denotes an insulating plate.

Each of the electrolytes was prepared as follows: ethylene carbonate (EC) and ethyl methyl carbonate (EMC) were mixed in a weight ratio of EC:EMC=1:2 to prepare a solvent, and LiPF₆ was dissolved as an electrolyte salt in the solvent so as to have a concentration of 1.0 mol/liter. To this solution, any one of the carboxylic anhydride organic compounds to be described below was added in the contents of 0.01, 0.05, 0.1, 1.0, 5.0, 10.0 and 20.0% by weight to prepare lithium secondary battery electrolytes.

It is to be noted that the carboxylic anhydrides used in Experimental Examples 1 to 7 were as follows: poly(adipic anhydride) (Experimental Example 1) as a chain-type carboxylic anhydride organic compound the molecule of which is symmetric; hexahydrophthalic anhydride (Experimental Example 2) and tetrahydrophthalic anhydride (Experimental Example 3) as cyclic-type carboxylic anhydride organic compounds the molecules of which are symmetric; dodecenyl succinic anhydride (Experimental Example 4) as a chain-type carboxylic anhydride organic compound the molecule of which is asymmetric; and methyltetrahydrophthalic anhydride (Experimental Example 5), methylhexahydrophthalic anhydride (Experimental Example 6) and methylcyclohexenedicarboxylic anhydride (Experimental Example 7) as cyclic-type carboxylic anhydride organic compounds the molecules of which are asymmetric.

### COMPARATIVE EXAMPLE 1

An electrolytes was prepared as follows: ethylene carbonate (EC) and ethyl methyl carbonate (EMC) were mixed in a weight ratio of EC:EMC=1:2 to prepare a solvent, and LiPF₆ was dissolved as an electrolyte salt in the solvent so as to have a concentration of 1.0 mol/liter. To this solution, vinylene carbonate (VC) was added in a content of 1.0% by weight to prepare a lithium secondary battery electrolyte.

### COMPARATIVE EXAMPLE 2

An electrolytes was prepared as follows: EC and EMC were mixed in a weight ratio of EC:EMC=1:2 to prepare a solvent, and LiPF₆ was dissolved as an electrolyte salt in the solvent so as to have a concentration of 1.0 mol/liter. To this solution, neither any of the carboxylic anhydride organic compounds described in Example 1 nor VC described in Comparative Example 1 was added.

### (Battery Storage Test I)

By using the lithium secondary batteries fabricated in the above described manners, a storage test was carried out. Each of the batteries was charged at 25° C. with a constant charging current of 1200 mA and a constant voltage of 4.1 V, and discharged with a constant discharging current of 1200 mA down to a battery voltage of 2.7 V. The process composed of this charging and this discharging made one cycle. As a preliminary processing, two cycles of the above described charge-discharge process were carried out (hereinafter, this preliminary processing step is referred to as initialization), and thereafter the thus initialized battery was charged so as to reach a battery voltage of 3.65 V with a constant current of 1200 mA and a constant voltage of 4.1 V for 3 hours; the date and time of the completion of such charging was set as the 0-th day of the storage test, and the battery storage test was carried out at 50° C.

Table 1 shows the discharge capacity retention rates after 60 days of the lithium secondary batteries using the electrolytes described in experimental examples 1 to 7 and Comparative Examples 1 and 2. The residual discharge capacity as referred to herein means the residual electric capacity found when the battery is discharged with a constant discharge current of 1200 mA down to a battery voltage of 2.7 V. The discharge capacity retention rate means the discharge capacity measured at the second cycle of the two cycles of charge-discharge, additionally carried out after the measurement of the residual discharge capacity subsequent to the storage test, represented as a value relative to the discharge capacity at the second cycle of the initialization assumed to be 100.

TABLE 1
Capacity retention rates (%) with compounds mixed in the electrolyte

| | Type of | Presence/ | | | | | | | | |
|---|---|---|---|---|---|---|---|---|---|---|
| | carboxylic | absence of | Addition amount wt % (relative to electrolyte weight) | | | | | | | |
| Compound | anhydride | double bond | 0 | 0.01 | 0.05 | 0.1 | 1 | 5 | 10 | 20 |

| | | | | | | | | | | | |
|---|---|---|---|---|---|---|---|---|---|---|---|
| Experimental | Poly(adipic anhydride) | Symmetric/ | Absent | — | 89.0 | 90.2 | 90.6 | 88.6 | 86.3 | 82.6 | Insoluble |
| Example 1 | | chain-type | | | | | | | | | |
| Experimental | Hexahydrophthalic anhydride | Symmetric/ | Absent | — | 89.3 | 90.7 | 91.8 | 92.7 | 92.2 | 85.2 | 82.8 |
| Example 2 | | cyclic-type | | | | | | | | | |
| Experimental | Tetrahydrophthalic anhydride | Symmetric/ | Present | — | 87.2 | 87.9 | 91.5 | 92.8 | 90.1 | 88.5 | 87.3 |
| Example 3 | | cyclic-type | | | | | | | | | |
| Experimental | Dodecenyl succinic anhydride | Asymmetric/ | Present | — | 87.1 | 87.8 | 88.4 | 89.4 | 88.5 | 87.6 | 84.2 |
| Example 4 | | chain-type | | | | | | | | | |
| Experimental | Methyltetrahydrophthalic anhydride | Asymmetric/ | Present | — | 85.5 | 90.0 | 91.8 | 93.1 | 92.8 | 89.9 | 85.9 |
| Example 5 | | cyclic-type | | | | | | | | | |
| Experimental | Methylhexahydrophthalic anhydride | Asymmetric/ | Absent | — | 82.7 | 87.8 | 89.4 | 90.7 | 87.2 | 87.0 | 85.3 |
| Example 6 | | cyclic-type | | | | | | | | | |
| Experimental | Methylcyclohexenedicarboxylic | Asymmetric/ | Present | — | 84.9 | 85.7 | 90.6 | 91.5 | 90.6 | 89.6 | 85.7 |
| Example 7 | anhydride | cyclic-type | | | | | | | | | |
| Comparative | Vinylene carbonate | — | — | — | 81.5 | 82.9 | 83.2 | 85.8 | 85.3 | 83.5 | 81.9 |
| Example 1 | | | | | | | | | | | |
| Comparative | — | — | — | 80.9 | — | — | — | — | — | — | — |
| Example 2 | | | | | | | | | | | |

As can be seen from the discharge capacity retention rates shown in Table 1, the cases where the chain-like or cyclic-like carboxylic anhydride organic compounds were used are superior in high-temperature storage performance to the cases where vinylene carbonate was used and no such compounds were used. Further, the addition amount of each of the carboxylic anhydride organic compounds is preferably 0.01% by weight or more and 10% by weight or less. It is obvious that the addition amount of the carboxylic anhydride organic compound is preferably 0.03% by weight or more and 5% by weight or less. Thus, when the carboxylic anhydride organic compound was added in a content of 20% by weight or more, some batteries did not operate because of the increased viscosity of the electrolyte. In some cases, the carboxylic anhydride organic compounds were not dissolved in the electrolyte and hence the batteries did not operate. However, the use of an electrolyte having a higher dielectric constant conceivably enables the dissolution of the carboxylic anhydride organic compounds in the electrolyte and hence the batteries are made to be operative. On the other hand, when the addition amount of the carboxylic anhydride organic compound is less than 0.01% by weight, it is conceivable that the electrode surface cannot be coated appropriately and hence no sufficient coating effect can be attained.

As can also be seen from the results of Experimental Examples 5 and 6, as far as the presence/absence of the carbon-carbon double bond is concerned, Experimental Example 5 having a carbon-carbon double bond is superior, in high-temperature storage performance, to Experimental Example 6.

### (X-Ray Photoelectron Spectroscopic Method)

The batteries of Example 1 each having the addition amount of 1.0% by weight were subjected to the 60-day high-temperature storage performance measurement and were discharged down to 2.7 V with a constant current of 1200 mA. Each of these batteries was placed in a glove box filled with high-purity argon gas, and the battery can was cut with a pipe cutter while attention was being paid so as to keep the electrodes out of contact with any metallic portions (so as for the electrodes not to be short-circuited). The rolled electrode group was pulled out of the thus cut battery, and a piece of the negative electrode was cut out. The cut out piece of the negative electrode was washed with dimethyl carbonate and dried at 60° C. for 12 hours, and then the surface of the negative electrode piece was subjected to the observation with the X-ray photoelectron spectroscopic method (see Note 1). On the assumption that the deterioration of the binder was negligible, the measurement results of each of the batteries of Example 1 with the addition amount of 1.0% by weight were compared with those of the battery of Comparative Example 2 under the condition that the integrated intensities of —CF₂ of both batteries were assumed the same; thus, the intensity of the C—O bond was observed to be higher in intensity than the C═O bond. This can be interpreted that the used carboxylic anhydride organic compound was decomposed as shown in the following reaction formula (1) to make the ratio of the C—O bond to the C═O bond have a value of 2:1 as far as the reaction intermediate was concerned. It is readily inferred that in the cases involving two or more of the carboxylic anhydride groups in a molecule, the detection ratio may be at variance with that cited above.

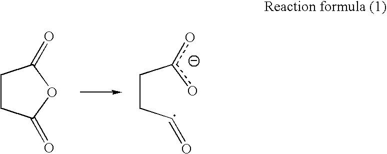

(Note 1) Description is made on the X-ray photoelectron spectroscopic method. The electrons constituting an atom undergo a certain strength of binding due to the nucleus. The kinetic energy of a photoelectron emitted by irradiation of X-ray (the excitation light) is given by (Excitation light energy)−(Bound energy). (To be exact, the energy loss corresponding to the surface work function is involved.) The binding strength, namely, the bound energy of an electron is given a value determined by the type of the atom and the orbital occupied by the electron. However, when the atom is a constituent of a compound or a crystal lattice, the bound energy of the electron is slightly varied as compared to that of the free atom. This slight variation is referred to as “chemical shift,” the utilization of which in the X-ray photoelectron spectroscopic method enables the identification of the chemical condition of the atom as well as the element type of the atom. For example, when the chemical shift of a carbon-carbon bond is corrected to be 294.1 eV, the shift of the peak of the —CF₂, having two highly electronegative F atoms bonded to one carbon atom, in PVDF (polyvinylidene fluoride: —CF₂CH₂—) used as the binder is observed at a largely shifted location of 294.4 eV.

### EXAMPLE 2

Description is made on a method in which the carboxylic anhydride organic compounds were mixed at the time of the negative electrode coating. The used negative electrode active material was the carbon material obtained by mechanically processing graphite carbon that was a carbon material having a high crystallinity so as to be decreased in the surface crystallinity. The negative electrode slurries were prepared by mixing and fully kneading the negative electrode active material, the NMP solution of PVDF, and any one of the carboxylic anhydride organic compounds added in the contents of 0.01, 0.05, 0.1, 1.0, 5.0, 10.0 and 20.0% by weight in relation to the weight of the electrolyte to be used. The mixing ratio between the negative electrode active material and PVDF was set at 90:10 by weight. Each of the slurries was uniformly and evenly coated on one surface of a 10 μm thick rolled copper foil (a negative electrode current collector). In the same manner as in the case of the positive electrode, each of the slurries was coated on both surfaces of the rolled copper foil and dried. After coating, the coated copper foil thus prepared was subjected to compression molding with a roll press, cut to a coating dimension of 5.6 cm in width and 54 cm in length, and a copper-foil lead tab was welded onto the cut copper foil to prepare a negative electrode plate. The positive electrode active material and the shape of each of the cylindrical batteries were the same as in Example 1. Each of the electrolytes was prepared as follows: EC and EMC were mixed in a weight ratio of EC:EMC=1:2 to prepare a solvent, and LiPF₆ was dissolved as an electrolyte salt in the solvent so as to have a concentration of 1.0 mol/liter. The carboxylic anhydride organic compounds used were: poly(adipic anhydride) as a chain-type carboxylic anhydride organic compound the molecule of which is symmetric; hexahydrophthalic anhydride and tetrahydrophthalic anhydride as cyclic-type carboxylic anhydride organic compounds the molecules of which are symmetric; dodecenyl succinic anhydride as a chain-type carboxylic anhydride organic compound the molecule of which is asymmetric; and methyltetrahydrophthalic anhydride, methylhexahydrophthalic anhydride and methylcyclohexenedicarboxylic anhydride as cyclic-type carboxylic anhydride organic compounds the molecules of which are asymmetric.

### (Battery Storage Test II)

The battery test was carried out by fabricating the batteries in the same manner as described in Example 1, except for the negative electrodes. Table 2 shows the discharge capacity retention rates after 60 days.

TABLE 2
Capacity retention rates (%) after 60 days with compounds mixed in the negative electrode slurry

| | | Type of | Presence/ | | | | | | | | |
|---|---|---|---|---|---|---|---|---|---|---|---|
| | | carboxylic | absence of | Addition amount wt % (relative to electrolyte weight) | | | | | | | |
| | Compound | anhydride | double bond | 0 | 0.01 | 0.05 | 0.1 | 1 | 5 | 10 | 20 |
| Experimental | Poly adipic anhydride | Symmetric/ | Absent | — | 80.1 | 81.1 | 84.2 | 84.6 | 83.6 | 78.6 | — |
| Example 11 | | chain-type | | | | | | | | | |
| Experimental | Hexahydrophthalic anhydride | Symmetric/ | Absent | — | 79.9 | 80.2 | 82.6 | 82.7 | 81.9 | 78.9 | — |
| Example 12 | | cyclic-type | | | | | | | | | |
| Experimental | Tetrahydrophthalic anhydride | Symmetric/ | Present | — | 80.3 | 81.9 | 83.2 | 84.3 | 83.1 | 80.1 | — |
| Example 13 | | cyclic-type | | | | | | | | | |
| Experimental | Dodecenyl succinic anhydride | Asymmetric/ | Present | — | 80.1 | 80.9 | 83.6 | 84.1 | 82.6 | 80.6 | — |
| Example 14 | | chain-type | | | | | | | | | |
| Experimental | Methyltetrahydrophthalic anhydride | Asymmetric/ | Present | — | 80.6 | 81.5 | 83.4 | 83.6 | 81.2 | 81.1 | — |
| Example 15 | | cyclic-type | | | | | | | | | |
| Experimental | Methylhexahydrophthalic anhydride | Asymmetric/ | Absent | — | 79.8 | 80.6 | 83.1 | 84.1 | 80.9 | 79.6 | — |
| Example 16 | | cyclic-type | | | | | | | | | |
| Experimental | Methylcyclohexenedicarboxylic | Asymmetric/ | Present | — | 80.1 | 81.3 | 82.2 | 83.1 | 80.4 | 79.2 | — |
| Example 17 | anhydride | cyclic-type | | | | | | | | | |
| Comparative | — | — | — | 79.9 | — | — | — | — | — | — | — |
| Example 3 | | | | | | | | | | | |

It was found that excellent high-temperature storage performance was attained when the chain-type or cyclic-type carboxylic anhydride organic compounds of the present invention were mixed in the negative electrode slurries at the time of the negative electrode coating. The addition amount of each of the chain-type and cyclic-type carboxylic anhydride organic compounds is preferably 0.01% by weight or more and 5% by weight or less, and particularly preferably 0.05% by weight or more and 5% by weight or less. When the addition amount is less than 0.05% by weight, it is conceivable that the electrode surface cannot be coated appropriately and hence no sufficient coating effect can be attained. When 10% or more of a carboxylic anhydride organic compound was added, some batteries did not operate because the excessive carboxylic anhydride organic compound locally promoted the agglomeration of the negative electrode active material, and hence no homogeneous negative electrode material was prepared. From a comparison between Experimental Examples 12 and 13, namely, a comparison between the presence and absence of the carbon-carbon double bond, Experimental Example 13 involving the carbon-carbon double bond was found to be superior in high-temperature storage performance.

As can be seen from the above descriptions, lithium secondary batteries more excellent in high-temperature storage performance can be obtained by mixing the carboxylic anhydride organic compounds in the electrolyte or in the negative electrode slurry in predetermined amounts. Additionally, lithium secondary batteries more excellent in high-temperature storage performance can be obtained when the compounds having a molecular symmetry and a carbon-carbon double bond are used.

What is claimed is:

1. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the negative electrode active material is a carbon material having a crystallinity of the surface thereof lower than the crystallinity of the carbon material; and
the electrolyte comprises therein an organic compound having a carboxylic anhydride group.

2. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the negative electrode active material is a carbon material having a crystallinity of the surface thereof lower than the crystallinity of the carbon material; and
the electrolyte comprises therein an organic compound satisfying the following chemical formula (1) in which R₁ and R₂ each are a group having 1 to 20 carbon atoms and comprising at least one element selected from the group consisting of hydrogen, sulfur, oxygen, nitrogen, fluorine, chlorine, bromine and iodine.

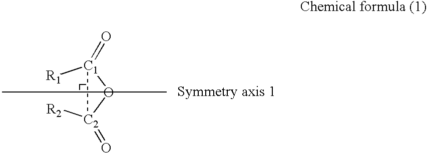

3. The lithium secondary battery according to claim 1, wherein the organic compound comprises at least one ring.

4. The lithium secondary battery according to claim 1, wherein the organic compound is comprised in a content of 0.01 to 10% by weight.

5. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the electrolyte comprises therein methyltetrahydrophthalic anhydride.

6. The lithium secondary battery according to claim 1, wherein the electrolyte is prepared by dissolving a lithium salt in a solvent comprising at least one selected from the group consisting of ethylene carbonate, propylene carbonate, gamma-butyrolactone, dimethyl carbonate, ethyl methyl carbonate and diethyl carbonate.

7. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the negative electrode active material is a carbon material having a crystallinity of the surface thereof lower than the crystallinity of the carbon material; and
a coating comprising a carboxylic anhydride group is formed on the negative electrode surface in contact with the electrolyte.

8. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the negative electrode comprises therein an organic compound having a carboxylic anhydride group.

9. The lithium secondary battery according to claim 8, wherein the organic compound satisfies the chemical formula (2) in which R₁ and R₂ each are a group having 1 to 20 carbon atoms and comprising at least one element selected from the group consisting of hydrogen, sulfur, oxygen, nitrogen, fluorine, chlorine, bromine and iodine.

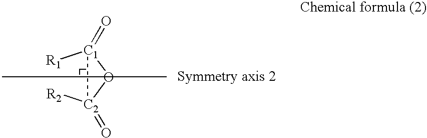

10. The lithium secondary battery according to claim 8, wherein the organic compound is a solid at 25° C. or a liquid having a boiling point higher than 240° C. under an atmospheric pressure of 1 atm.

11. The lithium secondary battery according to claim 8, wherein the organic compound is a carboxylic anhydride which is a solid at 25° C. or a liquid higher in boiling point than a dispersant comprised in the negative electrode.

12. A lithium secondary battery in which a positive electrode comprising a positive electrode active material capable of intercalating and deintercalating lithium ions and a negative electrode comprising a negative electrode active material capable of intercalating and deintercalating lithium ions are formed through the intermediary of an electrolyte, wherein:
the negative electrode active material is a carbon material having a crystallinity of the surface thereof lower than the crystallinity of the carbon material;
the electrolyte comprises therein an organic compound having a carboxylic anhydride group; and
the detected intensity of the C—O bond is stronger than the detected intensity of the C═O bond in the analysis of the surface of the negative electrode obtained by disassembling the lithium secondary battery after a 60-day storage.
